(19) United States
(12) Patent Application Publication
(10) Pub. No.: US 2012/0022931 A1
(43) Pub. Date: Jan. 26, 2012

(54) On-Line Bulk Acquisition of Digital Products

(76) Inventors: Farman A. Syed, San Jose, CA (US); Patrice Gautier, San Francisco, CA (US); Payam Mirrashidi, San Francisco, CA (US); David Neumann, Lake Oswego, OR (US); Mark Miller, San Francisco, CA (US); Wayne Yap, San Francisco, CA (US)

(21) Appl. No.: 12/841,081

(22) Filed: Jul. 21, 2010

(51) Int. Cl. G06Q 30/00

(52) U.S. Cl. 705/14.23; 705/26.1; 705/27.1

(57) ABSTRACT

Techniques and systems for acquisition of digital assets in a bulk fashion are disclosed. In one embodiment, upon accessing an online store, a digital asset and a quantity to be acquired (e.g., purchased) can be identified. In some cases, a discounted cost for acquisition of the quantity of the digital asset can be permitted, provided the quantity is sufficient. After payment of the discounted cost, a set of redeemable codes can be electronically provided. Each of the redeemable codes can be thereafter redeemed for acquisition of the digital asset.

### BACKGROUND OF THE INVENTION

Online media stores, such as iTunes™ Store, allow customers (i.e., online users) to purchase or rent media items, such as music or videos, or other digital assets, such as applications (software applications) over the Internet. Often, at online stores that distribute media or applications, numerous media or application items are made available and may be provided by various different content providers (e.g., music labels or movie companies) or different software companies or developers. Software tools, such as iTunes Producer™ and iTunes Connect™ available from Apple Inc. of Cupertino, Calif., can assist content or software application providers with online submission of media content or applications to the iTunes™ Store.

Unfortunately, online stores which sell media or software applications are typically configured for purchase of individual copies of a media item or software application. Also, when a media item or software application is electronically delivered (e.g., downloaded) after being purchased, the media item or software application can often only be used with a particular account or device. Hence, such online stores with electronic delivery do not facilitate purchase of digital assets in bulk. For example, it can also be difficult to purchase a particular digital product for each person of a group of persons. For example, a user wanting to purchase a digital product in quantities typically would have to repeat a tedious buying process. As such, users are dissuaded from buying digital products online for groups of users.

Accordingly, there is a need for improved approaches to facilitate purchase of common digital products for groups of users.

### SUMMARY

Techniques and systems for acquisition of digital assets in a bulk fashion are disclosed. In one embodiment, upon accessing an online store, a digital asset and a quantity to be acquired (e.g., purchased) can be identified. In some cases, a discounted cost for acquisition of the quantity of the digital asset can be permitted, provided the quantity is sufficient. After payment of the discounted cost, a set of redeemable codes can be electronically provided. Each of the redeemable codes can be thereafter redeemed for acquisition of the digital asset.

In general, embodiments can be implemented in numerous ways, including as a method, system, device, or apparatus (including graphical user interface or computer readable medium). Several embodiments of the invention are discussed below.

As a method for purchasing a digital media asset in bulk quantities, one embodiment can include at least receiving a bulk purchase request for a quantity of an identified digital asset, and initiating payment of a purchase cost for the quantity of an identified digital asset. The embodiment can also include generating a set of product redemption codes, where each of the redemption codes are redeemable for the identified digital asset. The embodiment can also include providing the set of product redemption codes in response to the bulk purchase request.

As a computer readable medium including at least computer program code tangibly stored thereon for facilitating purchase of a digital media asset in bulk quantities, one embodiment can, for example, include at least: computer program code for receiving a bulk purchase request for a quantity of an identified digital asset; computer program code for initiating payment of a purchase cost for the quantity of an identified digital asset; computer program code for generating a set of product redemption codes, each of the redemption codes being redeemable for the identified digital asset; and computer program code for providing the set of product redemption codes in response to the bulk purchase request.

As a method for purchasing a digital media asset in bulk quantities, one embodiment can include at least accessing an online store for purchase of any of a plurality of digital assets, the online store supporting bulk purchase of digital assets. The embodiment can also include receiving a selection a digital asset for bulk purchase, and presenting product information for the selected digital asset. Still further, the embodiment can include receiving an identification of a quantity of the selected digital asset to be purchased, presenting a discounted cost for the identified quantity of the selected digital asset to be purchased, and then receiving a request to purchase of the identified quantity of the selected digital asset at the discounted cost.

As a computer readable medium including at least computer program code tangibly stored thereon for purchasing a digital media asset in bulk quantities, one embodiment can, for example, include at least: computer program code for accessing an online store for purchase of any of a plurality of digital assets, the online store supporting bulk purchase of digital assets; receiving a selection a digital asset for bulk purchase; computer program code for presenting product information for the selected digital asset; computer program code for receiving an identification of a quantity of the selected digital asset to be purchased; computer program code for presenting a discounted cost for the identified quantity of the selected digital asset to be purchased; and computer program code for receiving a request to purchase of the identified quantity of the selected digital asset at the discounted cost.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a product submission and distribution system according to one embodiment.

FIG. 2 is a block diagram of a bulk purchase manager according to one embodiment.

FIG. 3 is a flow diagram of a server-side bulk purchase process according to one embodiment.

FIG. 4 is a flow diagram of a client-side bulk purchase process according to one embodiment.

FIGS. 5A and 5B are flow diagrams of a server-side bulk purchase process according to one embodiment.

FIGS. 6A, 6B and 6C are flow diagrams of a client-side bulk purchase process according to one embodiment.

FIG. 7 shows an exemplary computer system suitable for use with at least one embodiment.

### DETAILED DESCRIPTION OF CERTAIN EMBODIMENTS

Techniques and systems for acquisition of digital assets in a bulk fashion are disclosed. In one embodiment, upon accessing an online store, a digital asset and a quantity to be acquired (e.g., purchased) can be identified. In some cases, a discounted cost for acquisition of the quantity of the digital asset can be permitted, provided the quantity is sufficient. After payment of the discounted cost, a set of redeemable codes can be electronically provided. Each of the redeemable codes can be thereafter redeemed for acquisition of the digital asset.

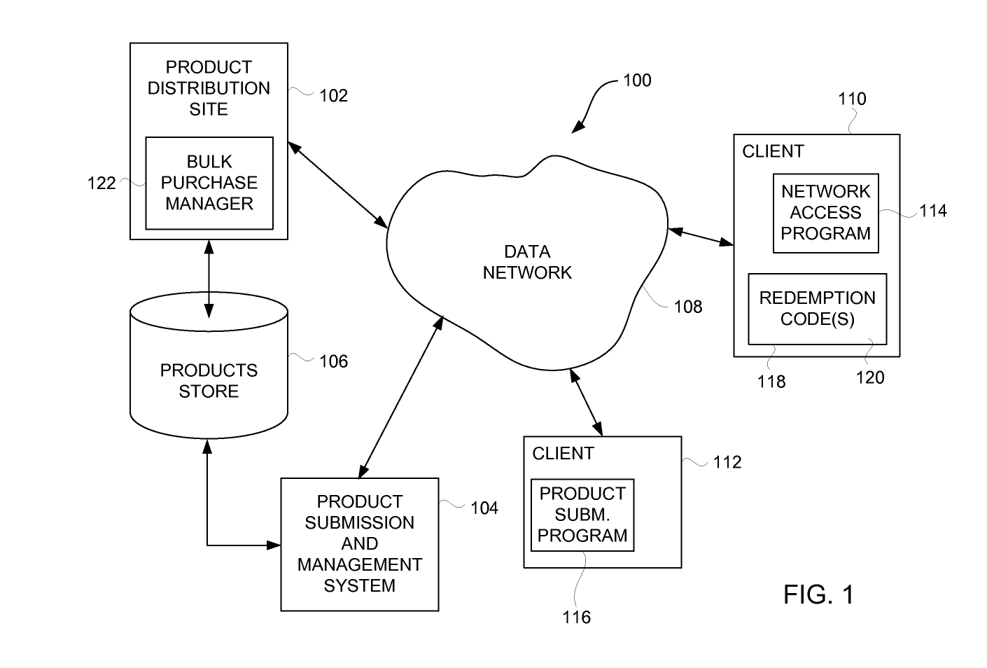

Embodiments of various aspects of the invention are discussed below with reference to FIGS. 1-7. However, those skilled in the art will readily appreciate that the detailed description given herein with respect to these figures is for explanatory purposes as the invention extends beyond these limited embodiments.

FIG. 1 is a block diagram of a product submission and distribution system 100 according to one embodiment of the invention. The product submission and distribution system 100 includes a product distribution site 102. The product distribution site 102 provides an online access point for distribution of various digital products. For example, the product distribution site 102 can be referred to as an online store. A product submission and management system 104 operates to receive submissions of digital products from various digital product submitters. The product submission and management system 104 can process submission of digital products and authorize distribution of approved digital products. The digital products can be stored in a products store 106. In one embodiment, the products store 106 includes a mass data store and/or one or more databases. The products store 106 provides mass storage of the numerous digital products that are available for distribution (e.g., purchase). For example, digital products that have been purchased can be accessed from the products store 106 over a data network 108 by way of the product distribution site 102. Examples of digital products are computer program products such as applications (or application programs), animations, or presentations, or digital media assets such as songs, movies, audiobooks, etc.

The product submission and distribution system 100 also includes a first client 110 and a second client 112. Typically, the product submission and distribution system 100 would include a plurality of different clients 110, 112. The first client 110 includes a network access program 114. The second client 112 includes a product submission program 116. Some clients can also include both the network access program 114 and the product submission program 116. The network access program 114 is an application program (e.g., software application) that operates on the first client 110, which is a computing device. One example of a suitable network access program is a network browser (e.g., Microsoft Explorer or Safari). Another example of a suitable network access program is iTunes™ offered by Apple Inc. The first client 110 can be coupled to the product distribution site 102 through the data network 108. Hence, any of the first clients 110 can interact with the product distribution site 102 to review, purchase and/or manage digital products.

The product submission program 116 is also an application program (e.g., software application) that operates on the second client 112, which is a computing device. The product submission program 116 is used to submit digital products to the product submission and management system 104 for eventual distribution by the media distribution site 102.

In submitting a digital product to the products to the product submission and management system 104, media data, descriptive information, representative images, distribution control, and/or bulk purchase availability can be indicated. For bulk purchase availability, for a given digital product being submitted (or for a submitter generally), an indication of bulk purchase availability can be designated and/or specific options to be available for bulk purchase can be denoted. In one embodiment, a submitter can accept or decline predetermined purchasing discounts on one or more of its digital products. In another embodiment, a submitter can authorize bulk purchase discounts and set one or more bulk purchasing tiers with associated qualifying quantity and cost reduction. Although the network access program 114 and the product submission program 116 are shown in FIG. 1 as separate programs, it should be understood that such programs can be integrated into a single program or reside on the same client machine.

In the product submission and distribution system 100 shown in FIG. 1, the digital products are submitted to the product submission and management system 104 by way of the product submission program 116. The digital products that have been submitted (e.g., via the second client 112) are processed and then, if accepted, stored in the products store 106 for distribution. Thereafter, the stored digital products are available to be purchased from the product distribution site 102.

The product submission and distribution system 100 allows a user of the client 110 to utilize the network access program 114 to browse, search or sort through a plurality of digital products that can be purchased from the product distribution site 102. The network access program 114 may also allow the user to preview or demo some or all of a digital product. In the event that the user of the network access program 114 desires to purchase a particular digital product, the user (via the network access program 114) and the product distribution site 102 can engage in an online commerce transaction in which the user pays for access rights to the particular digital product. In one embodiment, a credit card associated with the user is credited for a purchase or rental amount of the particular digital product. In one embodiment, a user account associated with the user can be charged for a purchase amount of the particular digital product. In still other embodiments, the user need not pay (i.e. free) for access rights to the particular digital product.

Upon purchasing a particular digital product, the product distribution site 102 permits the digital data for the particular digital product to be retrieved from the products store 106 and then delivered (e.g., downloaded) from the product distribution site 102 to the requesting client 110 through the data network 108. In this regard, the product distribution site 102 or some other delivery server (not shown) obtains the digital data corresponding to the particular digital product from the products store 106 and downloads such digital data through the data network 108 to the client 110. The downloaded digital data can then be stored on the client 110. In one embodiment, the downloaded digital data is encrypted as received at the client 110 but is decrypted and then perhaps re-encrypted before being persistently stored on the client 110. Thereafter, the client 110 can utilize (e.g., execute) the digital product at the client 110.

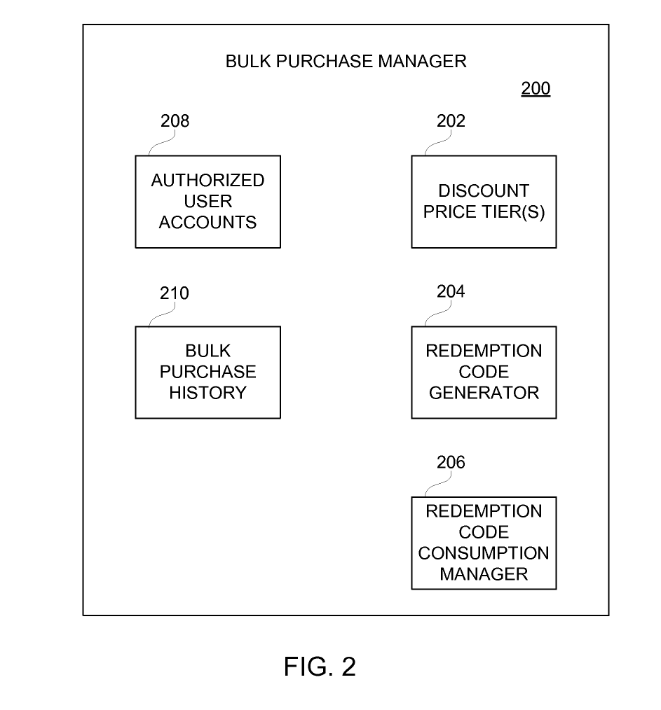

Besides purchasing access rights to a particular digital product for the single client 110, the product distribution site 102 can also support purchasing access rights in bulk quantities. By offering discounted pricing for bulk purchases, the product submission and distribution system 110 support users, such as educational institutions, businesses, charities, or religious organizations in purchasing digital products in quantities and often at a discount. The product distribution site 102 can include a bulk purchase manager 122. The bulk purchase manager 122 can manage bulk purchases via the online store provided by the product distribution site 102. The bulk purchase manager 122 can determine which of the digital products are available to be purchased in bulk quantities and, if so, which bulk purchase discount is available and when (e.g., minimum quantity). Additional information concerning the bulk purchase manager 122 is provided below with reference to FIG. 2.

The submission and purchase of the digital products can be achieved over the data network 108. In other words, the submission and purchase of the digital products can be achieved online. The purchase of media items online can also be referred to as electronic commerce (e-commerce). In one embodiment, the data network 108 makes use of at least a portion of the Internet. In one embodiment, the connections through the data network 108 between the product distribution site 102 and the clients 110, 112 can be through secure connections, such as Secure Sockets Layer (SSL). The clients 110, 112 can vary with application but generally are computing devices that have memory storage. Often, the clients 110, 112 are personal computers or other computing devices that are capable of storing and presenting media to their users. In one embodiment, one or more of the clients can be portable computing devices (e.g., laptop or network computers) or handheld computing devices (e.g., PDAs, smart phones, multi-function electronic devices, or media players).

Although the product distribution site 102, the product submission and management system 104 and the products store 106 are shown in FIG. 1 as being separate components, it should be understood that any of these components can be combined into one or more apparatus. For example, the product submission and management system 104 can be incorporated into the product distribution site 102. As another example, the products store 106 can be incorporated into the product distribution site 102 or the product submission and management system 104.

FIG. 2 is a block diagram of a bulk purchase manager 200 according to one embodiment. The bulk purchase manager 200 can, for example, correspond to one implementation of the bulk purchase manager 122 illustrated in FIG. 1.

A bulk purchase manager 200 includes storage for discount price tier(s) 202. The one or more discount price tiers 202 can specify availability of a bulk discount for purchases of sufficient quantity. A discount price tier can be defined by a bulk discount rule. In one implementation, the discount price tiers can be distinguished based on the quantity being ordered. For example, in a one tier system, if the quantity is greater than X. (e.g. 10), then the discount price tier can be applied. Although the discount price tier can vary with implementation, as one example, the discount price tier can specify a discount price per unit or a percentage reduction from a base price per unit. For example, if the base price per unit is $10, then if the discount price tier is available for a bulk purchase, each of the units within the bulk purchase can cost only $5 dollars, which is a 50% reduction. The discount price tiers 202 can also store a plurality of different pricing tiers. The tiers can be distinguished based on quantity, such as 10 to 20 units can correspond to tier 1, 21 to 50 units can correspond to tier 2, and 51 or more in units can correspond to tier 3. In tier 1, the discount can be 20%, in tier 2 the discount can be 40%, and in tier 3 the discount can be 60%.

The bulk purchase manager 200 can also include a redemption code generator 204. The redemption code generator 204 operates to generate a plurality of codes, one for each of the units being purchased in the bulk purchase. The redemption code generator 204 can itself generate a plurality of codes. Alternatively, the plurality of codes can be generated from a remote server and provided to the redemption code generator 204.

The bulk purchase manager 200 can also includes a redemption code consumption of manager 206. The redemption code consumption manager 206 can manage tracking and monitoring of usage of the redemption codes. For example, once a redemption code has been redeemed, the redemption code consumption manager 206 can store an indication that the particular redemption code has been retained and us is no longer further redeemable. The redemption code manager 206 can also store information associated with the account holder that has redeemed redemption code.

The bulk purchase manager 200 can also store information regarding authorized user accounts 208. In one embodiment, in order to participate in bulk purchasing with respect to a product distribution side, such as the product distribution side 102 illustrated in FIG. 1, users can be required to be authorized. For example, users can be authorized by establishing an account with the product distribution site 102. In one implementation, a user submits an application for an account and the applications submitted are reviewed (e.g., in person and/or by computer) to determine whether an account is appropriate. Once an account is established, a user ID and password are utilized in order to log into the product distribution side so that bulk purchases can be performed at a discount.

The bulk purchase manager 200 can further include storage for bulk purchase history 210. The bulk purchase history 210 can store information regarding prior bulk purchases performed by a particular account holder. The bulk purchase history 210 can be accessed and presented to an account holder.

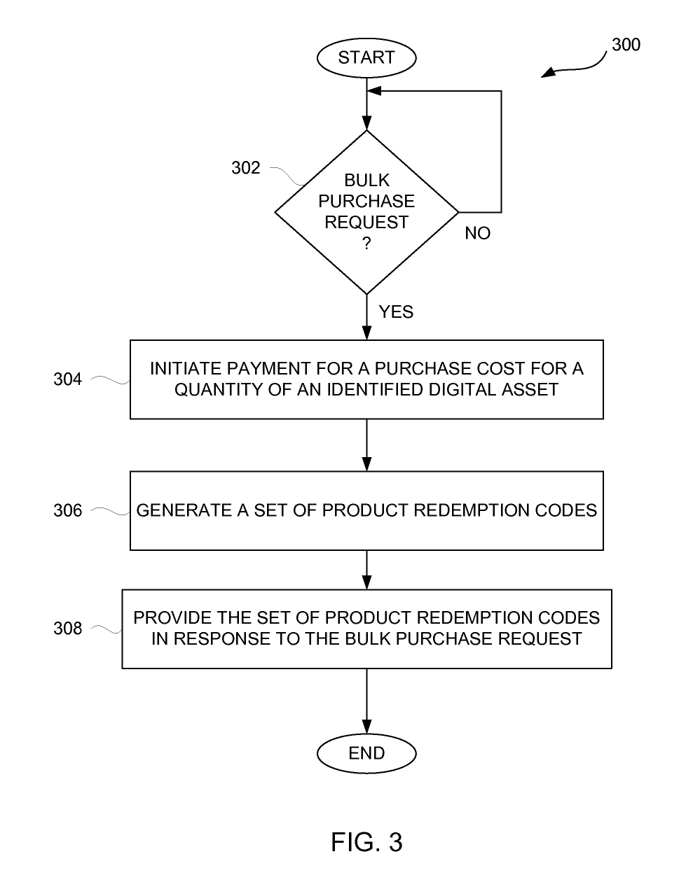

FIG. 3 is a flow diagram of a server-side bulk purchase process 300 according to one embodiment. The server-side bulk purchase process 300 can, for example, be performed by a server machine, such as the product distribution site 102 and/or in the bulk purchase manager 122 illustrated in FIG. 1.

The server-site bulk purchase process 300 can begin with a decision 302 that determines whether a bulk purchase request has been received. When the decision 302 determines that a bulk purchase request has not been received, and the server-side bulk purchase process 300 awaits such a request. In other words, the server-side bulk purchase process 300 is effectively invoked once a bulk purchase request has been received.

After the decision 302 determines that a bulk purchase request has been received, payment for a purchase cost for a quantity of an identified digital asset can be initiated 304. Here, the server machine performing the server-side bulk purchase process 300 can receive from a corresponding client machine an identification of a digital asset to be purchased along with a quantity of such to be purchased. If the quantity of the digital asset being purchased is sufficiently large, the cost for the digital assets can be discounted. In other words, bulk pricing can be provided if sufficient quantities are being purchased. The payment for the purchase cost can be processed in any of a variety of ways, including electronic payments or transfers.

After the payment for the purchase cost has been initiated 304, a set of product redemption codes can be generated 306. Each of the pension codes allows the possessor to utilize the redemption code to acquire the identified digital asset. A redemption code is a string of alphanumeric characters that provide a unique code for a particular authorized redemption. As an example, a redemption code couple be a 16-character alphanumeric string such as “XXMPF8BL6B4K35C5”. Next, the set of product redemption codes can be provided 308 in response to the bulk purchase request. Following the block 308, the server-side bulk purchase process 300 can end.

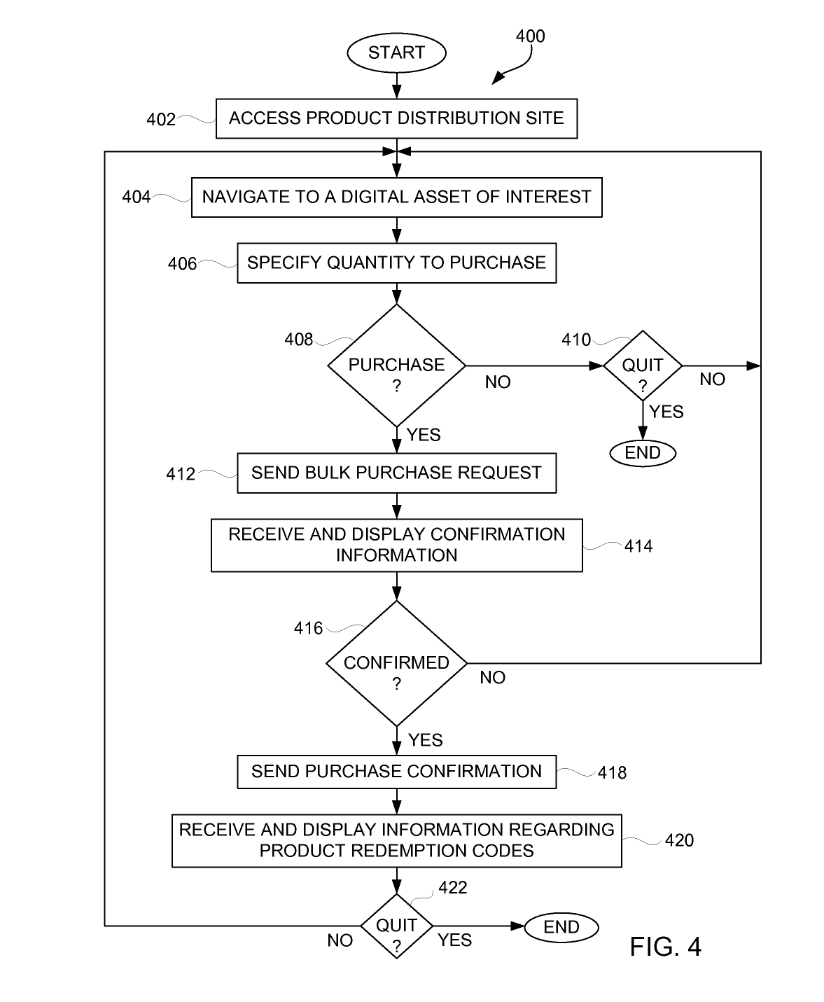

FIG. 4 is a flow diagram of a client-side bulk purchase process 400 according to one embodiment. The client-side bulk purchase process 400 can, for example, be performed on a client, such as the client 110 illustrated in FIG. 1.

The client-side bulk purchase process 400 can access 402 a product distribution side. The product distribution site is, for example, the product distribution site 102 illustrated in FIG. 1. The product distribution site can host an online store for digital assets (e.g., music, video, games, software applications, audiobooks, etc.). Once the product distribution site has been accessed 402, the client-side bulk purchase process 400 can navigate 404 to a digital asset of interest. The navigation can concern searching or browsing (e.g., by a user) to locate a digital asset of interest at the product distribution site (e.g., online store). Once the digital asset of interest has been navigated to and thus identified, a quantity to be purchased can be specified 406. In other words, the digital asset of interest, once identified, can be purchased in bulk quantities. If the user desires to purchase the digital asset interests in bulk, they can specify 406 a quantity to be purchased.

A decision 408 can then determine whether the digital asset is to be purchased 408 in accordance with the quantity that has been specified 406. When the decision 408 determines that purchase of the digital asset has not yet been requested, the client-side bulk purchase process 400 can determine 410 whether the client-side bulk purchase process 400 should quit. When the decision 410 determines that the client-side bulk purchase process 400 should quit, then the client-side bulk purchase process 400 can end. Alternatively, when the decision 410 determines that the client-side bulk purchase process 400 should not end, the processing can return to repeat the block 404 and subsequent blocks.

On the other hand, when the decision 408 determines that the digital asset of interest is to be purchased in the quantity specified (i.e., bulk quantities), a bulk purchase request can be sent 412. Here, the client machine can operate to send 412 a bulk purchase request to the product distribution site where the bulk purchase request can be processed. The product distribution site typically requires that any purchase request be confirmed. Hence, after the bulk purchase request has been sent 412, confirmation information can be received and displayed 414. The confirmation information can be displayed as a confirmation page that requests that the user of the client machine confirm that the bulk purchase is to be performed. After the confirmation information has been received and displayed 414, a decision 416 can determine whether the bulk purchase request has been confirmed. When the decision 416 determines that the bulk purchase request has not been confirmed, the client-side bulk purchase process 400 can return to repeat the block 404 so that the same or a different digital asset of interest can be navigated to been similarly processed.

Alternatively, when the decision 416 determines that the purchase request has been confirmed, the purchase confirmation can be sent 418 to the product distribution site. Thereafter, the client-side bulk purchase process 400 receives and displays 420 information regarding product redemption codes. Here, the product distribution site receives the bulk purchase request, and carries out or manages processing to effectuate the bulk purchase request. In response to the bulk purchase request, the client machine can receive and display 420 the product redemption codes. The product redemption codes can then be stored and subsequently distributed as desired.

Next, a decision 422 determines whether the client-side bulk purchase process 400 should quit. When the decision 422 determines that the client-side bulk purchase process 400 should not quit, the processing can return to repeat the block 404 and subsequent blocks. Alternatively, when the decision 422 determines that the client-side bulk purchase process 400 should end, the client-side bulk purchase process 400 can end.

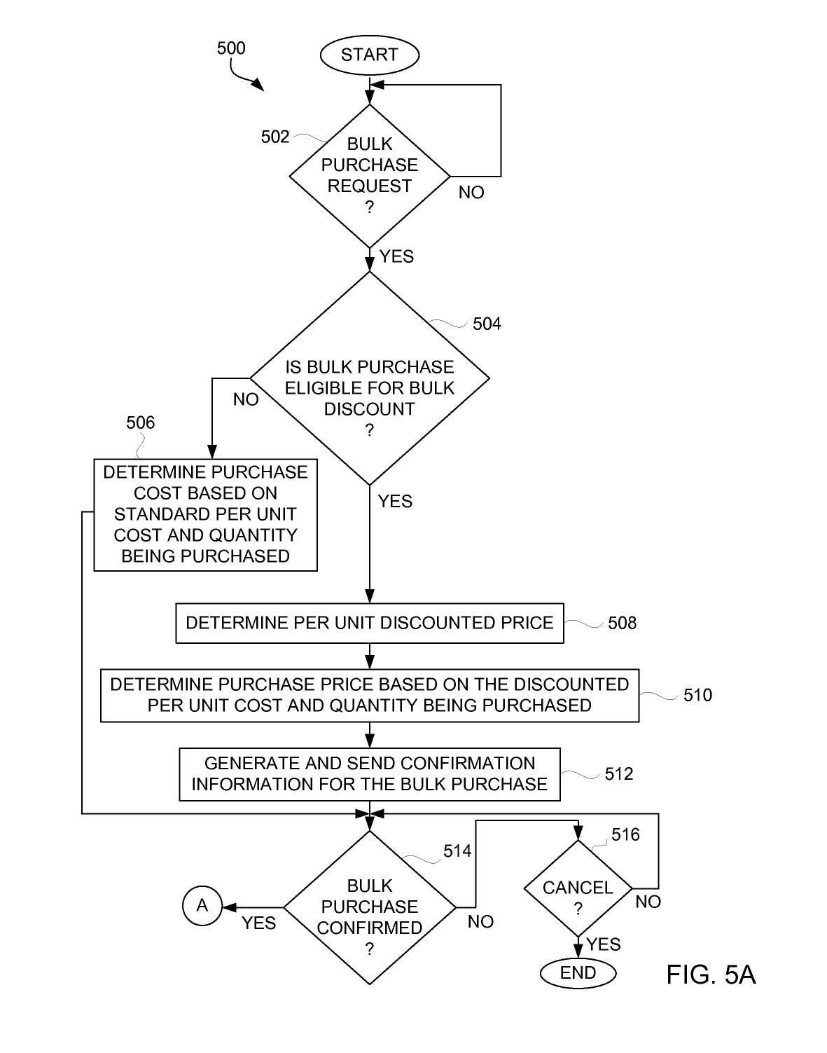

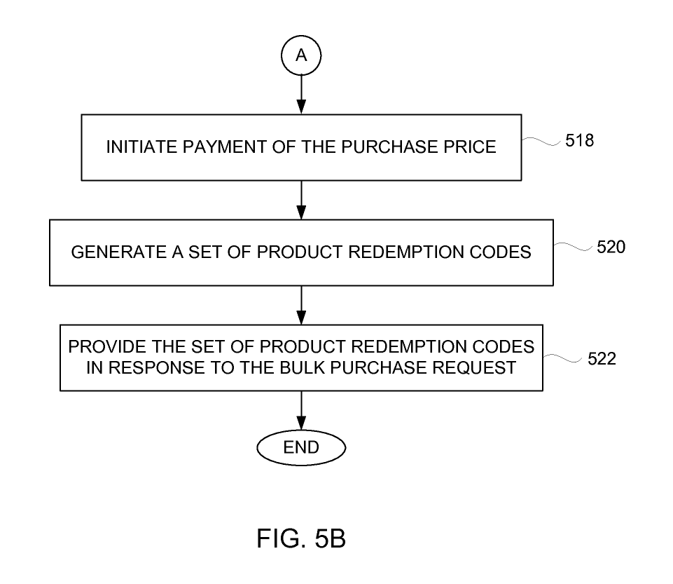

FIGS. 5A and 5B are flow diagrams of a server-side bulk purchase process 500 according to one embodiment. The server-side bulk purchase process 500 can, for example, be performed by a server machine, such as the product distribution site 102 and/or in the bulk purchase manager 122 illustrated in FIG. 1.

The server-side bulk purchase process 500 can begin with a decision 502. The decision 502 determines whether a bulk purchase request has been received. When the decision 502 determines that a bulk purchase request has not been received, the server-side bulk purchase process 500 awaits such a request. Once the decision 502 determines that a bulk purchase request has been received, a decision 504 can determine whether the bulk purchase being requested is eligible for a bulk discount. When the decision 504 determines that the bulk purchase is not eligible for a bulk discount, a purchase cost can be determined 508 based on a standard per-unit cost and a quantity being purchased.

On the other hand, when the decision 504 determines that the bulk purchase is eligible for a bulk discount, a per-unit discounted price can be determined 508. In one implementation, the per-unit discounted price is based on the quantity being purchased in the bulk purchase. For example, the per-unit discounted price can be available only if a minimum quantity (or threshold quantity) is being purchase. As discussed above, there can be one or more price tiers that can be associated with different per-unit discounted prices.

In any case, once the per-unit discounted price has been determined 508, a purchase cost can be determined 510 based on the discounted per-unit price and quantity being purchased. After the purchase cost has been determined 510, confirmation information for the bulk purchase can be generated and sent 512 to the corresponding client machine.

Following the block 512 or following the block 506, a decision 514 can determine whether the bulk purchase has been confirmed. When the decision 514 determines that the bulk purchase has not yet been confirmed, a decision 516 can determine whether the bulk purchase request has been canceled. When the decision 516 determines that the bulk purchase request has been canceled, the server-side bulk purchase process 500 can end. Alternatively, when the decision 516 determines that the server-side bulk purchase process 500 should not end, the processing returns to repeat the block 514 to wait confirmation of the bulk purchase.

Once the decision 514 determines that the bulk purchase has been confirmed, payment of the purchase price for the bulk purchase can be initiated 518. Here, the payment initiation can be provided at the product distribution site so that the purchase price is charged to the requestor (e.g., user of client machine), such as through credit or debit to a credit card, debit card or user account. A set of product redemption codes can then be generated 520. The set of product redemption codes can include one product redemption code for each of the quantity of the digital assets being purchased in bulk. After the set of product redemption codes has been generated 520, the set of product redemption codes can be provided 522 in response to the bulk purchase request. For example, the set of product redemption codes can be electronically transmitted to the requestor or to particular recipients. Following the block 522, the server-side bulk purchase process 500 can end. It should be noted that in an alternative embodiment, the block 518 can be bypassed or can result in no actual payment if the purchase cost is zero (i.e., fee).

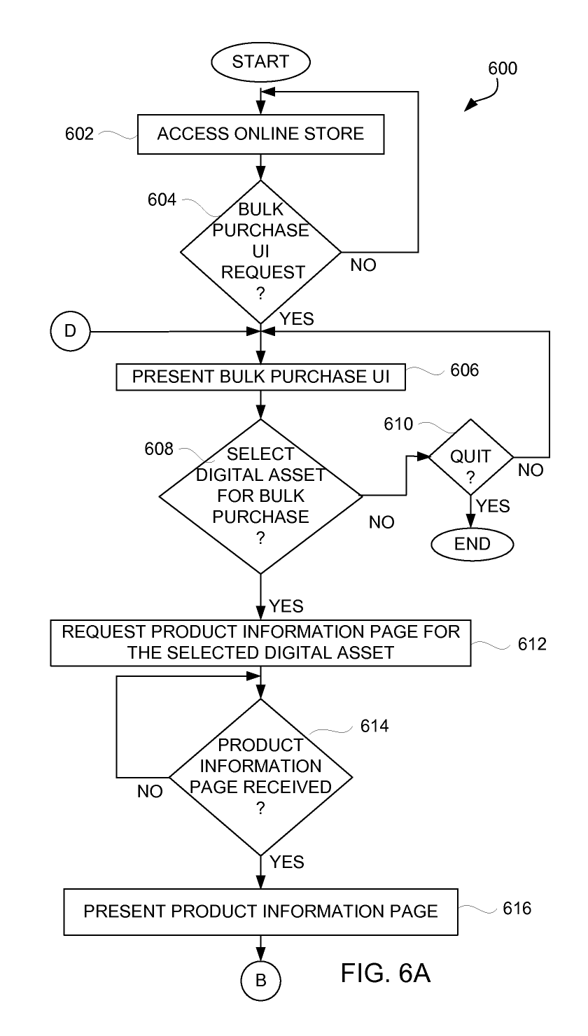

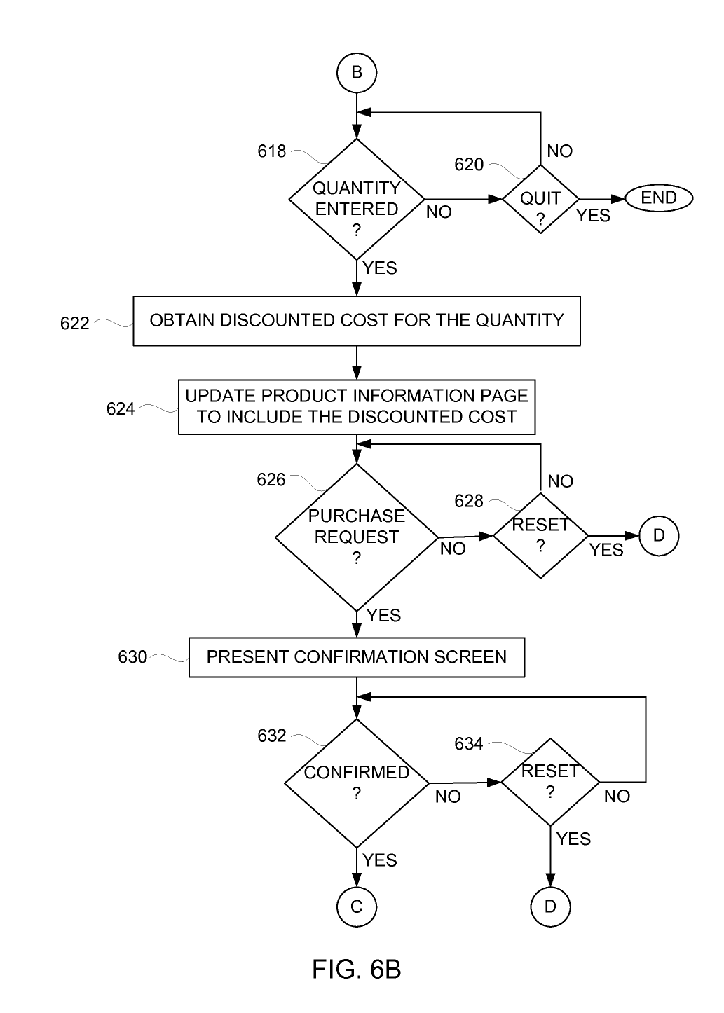

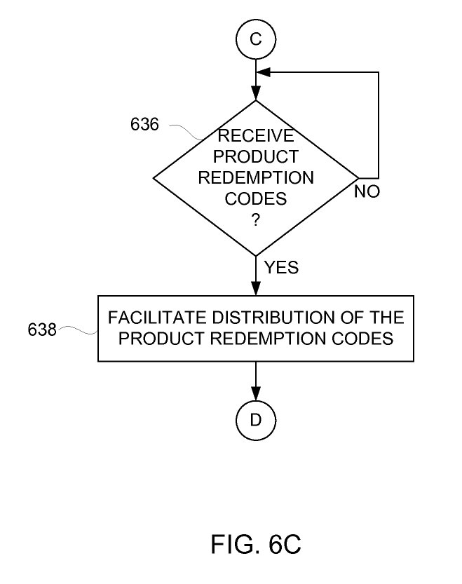

FIGS. 6A, 6B and 6C are flows diagram of a client-side bulk purchase process 600 according to one embodiment. The client-side bulk purchase process 600 can, for example, be performed on a client, such as the client 110 illustrated in FIG. 1.

The client-side bulk purchase process 600 can access 602 an online store. The online store can support bulk purchase of any of a number of different digital assets. A decision 604 can then determine whether a bulk purchase user interface request has been received. For example, a user of the client (client machine) can interact to request a bulk purchase user interface. When the decision 604 determines that a bulk purchase user interface request has not been received, the client-site bulk purchase process 600 can return to repeat the block 602 so that interaction with the online store can continue.

Alternatively, when the decision 604 determines that a bulk purchase user interface request has been received, a bulk purchase user interface can be presented 606. For example, the bulk purchase user interface can be presented 606 on the client. For example, the bulk purchase user interface can be displayed on a display screen associated with the client.

Next, a decision 608 can determine whether a digital asset for bulk purchase has been selected. When the decision 680 determines that a digital asset for bulk purchase has not yet been selected, a decision 610 can determine whether the client-side bulk purchase process 600 should end. When the decision 610 determines that the client-side bulk purchase process 600 should end, the client-site bulk purchase process 600 can end. Alternatively, when the decision 610 determines that the client-side bulk purchase process should not end, the processing returns to repeat block 606 and subsequent blocks.

Once the decision 680 determines that a digital asset for bulk purchase has been selected, a product information page for the selected digital asset can be requested 612. A decision 614 can then determine whether the product information page has been received. Here, the product information page can be requested and thus received from a server machine. When the decision 614 determines that the product information page is not yet been received, the server-side bulk purchase process 600 awaits receipt of the product information page. Once the decision 614 determines that the product information page has been received, a product information page can be presented 616. Here, the product information page can be presented at the client, such as by displaying the product information page on a display device associated with the client. From the product information page, the user is able to review product information concerning the selected digital asset. The product information page can also facilitate user designation of a quantity of the selected digital asset to be acquired.

After the product information page has been presented 616, a decision 618 can determine whether a quantity of the selected digital asset to be acquired has been entered. For example, the user of the client can interact with the product information page being presented at the client to specify a quantity. When the decision 618 determines that a quantity for the selected digital asset has not been entered, a decision 620 can determine whether the client-side bulk purchase process 600 should end. When the decision 620 determines that the client-side bulk purchase process 600 should end, the client-site bulk purchase process 600 can end. Alternatively, when the decision 620 determines that a client-side bulk purchase process 600 should not end, the processing returns to repeat the block 618 to, for example, await the identification of a quantity.

On the other hand, once the decision 618 determines that a quantity has been entered, a discounted cost for the quantity can be obtained 622. Here, the discounted cost can depend upon the quantity, and the discounted cost can be determined by at least one bulk purchase rule. As an example, the bulk purchase rule can be that if the purchasing quantity is ten (10) or more, the bulk purchase price per unit is 50% of a base unit price (i.e., 50% discount). There can also be more than one level (tier) of bulk discount, such that greater quantities can yield greater discounts. The discounted cost can be determined at the client or at the remote server. In any case, after the discounted cost for the quantity has been obtained 622, the product information page (being previously presented 616) can be updated 624 to include the discounted costs. Alternatively, an additional page could be presented to displaying the discounted cost.

Next, a decision 626 can determine whether a purchase request has been received. When the decision 626 determines that a purchase request has not been received, a decision 628 can determine whether a reset request has been received. When the decision 628 determines that a reset request has been received, processing can return to the block 606 where the bulk purchase user interface can again be presented to effectively restart the purchase process. Alternatively, when the decision 628 determines that a reset request has not been received, the client-side bulk purchase process 600 can return to repeat the decision 626 to await a purchase request.

Once the decision 626 determines that a purchase request has been received, a confirmation screen can be presented 630. The confirmation screen request that the user of the client confirm the purchase request. After the confirmation screen has been presented 630, a decision 632 can determine whether the purchase has been confirmed. When the decision 632 determines that the purchase has not yet been confirmed, a decision 634 can determine whether a reset request has been received. When the decision 634 determines that a reset request has been received, the processing can proceed to block 606 and subsequent blocks so that the bulk purchase process can effectively be restarted. Alternatively, when the decision 634 determines that a reset request has not been received, the processing can return to repeat the decision 632 can determine whether the purchase request has been confirmed. Once the decision 632 determines that the purchase request has been confirmed, a decision 636 can determine whether product redemption codes have been received. Here, once the purchase request has been confirmed, the server machine processes the request and produces the product redemption codes. The server machine then delivers the product redemption codes electronically to the client. The decision 636 determines whether the product redemption codes have been received from the server machine. When the decision 636 determines that the product redemption codes have not yet been received, the client-side bulk purchase process 600 awaits the product redemption codes. Once the decision 636 determines that the product redemption codes have been received, distribution of the product redemption codes can be facilitated 638. For example, the client can receive the product redemption codes and thereafter distribute the product redemption codes as the user so desires. Each recipient of a product redemption code can utilize the code to obtain the selected digital asset. For example, a recipient could access the online store and provide the product redemption code to thereby retrieve an electronic copy of the selected digital item.

The manner by which the product redemption codes are distributed can very depending upon implementation. For example, the user of the client machine can send the product redemption codes to the recipients using electronic mail messages (which can include a hyperlink for direct redemption of the code). In one implementation, the product redemption codes can be provided to the client in a file with a format that is able to be utilized in a mail merge operation. In another implementation, the online store, the remote server or the client can provide additional support to facilitate distribution of the product redemption codes. For example, the user might provide names and electronic mail addresses for the recipients to the online store or the remote server, and then the online store or the remote server can distribute the product redemption codes to specified recipients. For example, the remote server can cause the product redemption codes to be sent the specified recipients using electronic mail messages (which can include a hyperlink for direct redemption of the code). As another example, the remote server can inform the specified recipients when they access the online store (and login to their user account) that they are able to receive a digital product (as the result of a group or bulk purchase). In any case, following the block 638, the client-side all purchase process 600 can proceed to block 606 so that another bulk purchase can processed in the same manner. Alternatively, the client-site bulk purchase process 600 could end after the block 638.

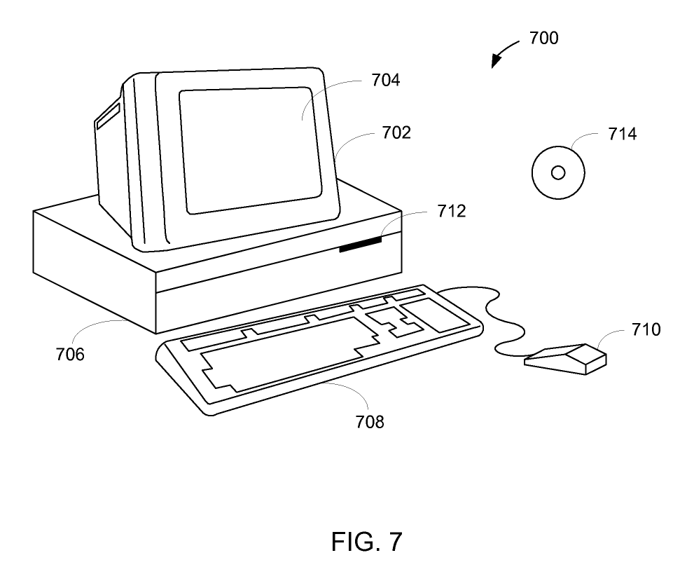

FIG. 7 shows an exemplary computer system 700 suitable for use with at least one embodiment. Although the client device need not be a personal computer, the client device can be implemented as the exemplary computer system 700 illustrated in FIG. 7. The computer system 700 includes a display monitor 702 having a single or multi-screen display 704 (or multiple displays), a cabinet 706, a keyboard 708, and a mouse 710. The cabinet 706 houses a processing unit (or processor), system memory and a hard drive (not shown). The cabinet 706 also houses a drive 712, such as a CD-ROM or floppy drive. The drive 712 can also be a removable hard drive, a Flash or EEPROM device, etc. Regardless, the drive 712 may be utilized to store and retrieve software programs incorporating computer code that implements some or all aspects of the invention, data for use with the invention, and the like. Although CD-ROM 714 is shown as an exemplary computer readable storage medium, other computer readable storage media including floppy disk, tape, Flash or EEPROM memory, memory card, system memory, and hard drive may be utilized. In one implementation, a software program for the computer system 700 is provided in the system memory, the hard drive, the CD-ROM 714 or other computer readable storage medium and serves to incorporate the computer code that implements some or all aspects of the invention.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The various aspects, features, embodiments or implementations of the invention described above can be used alone or in various combinations.

In the various embodiments discussed herein, in many cases, the bulk purchase was described with regard to a single product. However, it should be understood that in other embodiments, a set of digital products can be identified for purchase in bulk. The set of digital products can then be processed in a similar manner to that noted above. In this case, each of the recipients can received a redemption code that can be used to retrieve an electronic copy of each of the digital products in the set of digital products.

The advantages of the invention are numerous. Different aspects, embodiments or implementations may, but need not, yield one or more of the following advantages. One advantage of one embodiment is that bulk purchases of digital products can be supported by an online store. Another advantage of one embodiment is that bulk purchases can be made available at discounted prices if an owner or distributor so desires. Still another advantage of another embodiment is that a purchaser of bulk quantities can purchase a digital product, or a set of digital products, in bulk with substantial ease of use. Yet still another advantage of still another embodiment is that upon purchase of a quantity of a digital product, a user can receive a set of codes which can be distributed as desired. Still yet another advantage of one embodiment is that redemption of redemption codes can be monitored and managed so as to provide usage information as well as protect against fraudulent or improper usage.

Embodiments of the invention can, for example, be implemented by software, hardware, or a combination of hardware and software. Embodiments of the invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for purchasing a digital media asset in bulk quantities, the method comprising:
receiving a bulk purchase request for a quantity of an identified digital asset;
initiating payment of a purchase cost for the quantity of an identified digital asset;
generating a set of product redemption codes, each of the redemption codes being redeemable for the identified digital asset; and
providing the set of product redemption codes in response to the bulk purchase request.

2. A method as recited in claim 1, wherein the method comprises:
determining the purchase cost for the quantity of the identified digital asset being purchased.

3. A method as recited in claim 2, wherein the determining of the purchase cost is based on at least one discount bulk pricing rule.

4. A method as recited in claim 3, wherein the at least one discount bulk pricing rule renders per unit cost for the identified digital asset dependent on the quantity.

5. A method as recited in claim 4, wherein the purchase cost is dependent on a per unit cost and the quantity of the identified digital asset to be purchased, wherein the per unit cost used is dependent on the quantity.

6. A method as recited in claim 1, wherein the bulk purchase request identifies the purchase cost for the quantity of the identified digital asset being purchased.

7. A method as recited in claim 1, wherein the bulk purchase request is from a requestor, and
wherein the providing the set of product redemption codes comprises sending the set of product redemption codes to the requestor.

8. A method as recited in claim 7, wherein the sending comprises downloading a file containing at least the set of product redemption codes.

9. A method as recited in claim 7, wherein the sending comprises electronically transmitting at least the set of product redemption code.

10. A method as recited in claim 1, wherein the providing the set of product redemption codes comprises sending the set of product redemption codes to a plurality of designees to receive the identified digital asset.

11. A method as recited in claim 1, wherein the determining the purchase cost comprises:
determining a pricing tier based on the quantity, the pricing tier identifying a per unit cost; and
computing the purchase cost based on the quantity and the per unit cost per the pricing tier.

12. A method as recited in claim 1, wherein prior to the initiating the payment of the purchase cost for the quantity of the identified digital asset, determining whether the identified digital asset is authorized to be sold at discount bulk pricing.

13. A method as recited in claim 1, wherein the digital asset is a software program or a digital media asset.

14. A method as recited in claim 1, wherein the determining of the purchase cost for the quantity of the identified digital asset comprises:
determining whether the identified digital asset is eligible for discount pricing; and
determining the purchase cost for the quantity of the identified digital asset being purchased based on the discount pricing if it is determined that the identified digital asset is eligible for discount pricing.

15. A method as recited in claim 1, wherein the determining of the purchase cost for the quantity of the identified digital asset comprises:
determining whether the identified digital asset is eligible for discount pricing;
determining the purchase cost for the quantity of the identified digital asset being purchased based on the discount pricing if it is determined that the identified digital asset is eligible for discount pricing; and
determining the purchase cost for the quantity of the identified digital asset being purchased based on the non-discount pricing if it is determined that the identified digital asset is ineligible for discount pricing.

16. As a computer readable medium including at least computer program code tangibly stored thereon for facilitating purchase of a digital media asset in bulk quantities, the computer readable medium comprising:
computer program code for receiving a bulk purchase request for a quantity of an identified digital asset;
computer program code for initiating payment of a purchase cost for the quantity of an identified digital asset;
computer program code for generating a set of product redemption codes, each of the redemption codes being redeemable for the identified digital asset; and
computer program code for providing the set of product redemption codes in response to the bulk purchase request.

17. A method for purchasing a digital media asset in bulk quantities, the method comprising:
accessing an online store for purchase of any of a plurality of digital assets, the online store supporting bulk purchase of digital assets;
receiving a selection a digital asset for bulk purchase;
presenting product information for the selected digital asset;
receiving an identification of a quantity of the selected digital asset to be purchased;
presenting a discounted cost for the identified quantity of the selected digital asset to be purchased; and
receiving a request to purchase of the identified quantity of the selected digital asset at the discounted cost.

18. A method as recited in claim 17, wherein the method comprises:
receiving a set of product redemption codes for the identified quantity of the selected digital asset purchased.

19. A method as recited in claim 17, wherein the method comprises:
receiving distribution information for distribution of product redemption codes for the selected digital asset purchased to end users.

20. As a computer readable medium including at least computer program code tangibly stored thereon for purchasing a digital media asset in bulk quantities, the computer readable medium comprising:
computer program code for accessing an online store for purchase of any of a plurality of digital assets, the online store supporting bulk purchase of digital assets;
receiving a selection a digital asset for bulk purchase;
computer program code for presenting product information for the selected digital asset;
computer program code for receiving an identification of a quantity of the selected digital asset to be purchased;
computer program code for presenting a discounted cost for the identified quantity of the selected digital asset to be purchased; and
computer program code for receiving a request to purchase of the identified quantity of the selected digital asset at the discounted cost.
